(19) United States
(12) Patent Application Publication
(10) Pub. No.: US 2010/0224571 A1
(43) Pub. Date: Sep. 9, 2010

(54) ULTRASOUND BALLAST WATER TREATMENT DEVICE AND METHOD

(75) Inventors: Eilaz BABAEV, Minnetonka, MN (US); Paul Schmokel, Prior Lake, MN (US); Bobak Ha'Eri, Minneapolis, MN (US)

Correspondence Address: Bacoustics, LLC, 5929 BAKER ROAD, SUITE 470, MINNETONKA, MN, 55345, US

(73) Assignee: Bacoustics LLC, Minnetonka, MN (US)

(21) Appl. No.: 12/717,187

(22) Filed: Mar. 4, 2010

Related U.S. Application Data
(60) Provisional application No. 61/157,441, filed on Mar. 4, 2009.

(51) Int. Cl. C02F 1/36; C02F 1/76

(52) U.S. Cl. 210/747; 210/170.11

(57) ABSTRACT

The disclosure relates to the use of ultrasound for treating ballast water in ships. Specifically the invention discloses the use of ultrasound to activate chemicals to significantly improve there disinfectant properties at low concentrations. Ultrasound chemical activation allows for sonication of only a portion of the incoming ballast water, greatly increasing the cost-effectiveness of ballast water treatment. The ballast water treatment system may integrate with new or existing shipboard ballast systems attaching to the ballast inlet mains; mixing, sonicating and delivering the active substance as it feeds into the ballast tanks. Alternatively, when space or other factors are an issue it can be designed to achieve the same mixing, sonication and delivery from a small apparatus attached to the ballast tanks.

### BACKGROUND OF THE INVENTION

The disclosure relates to the use of ultrasound for treating water and wastewater. Specifically the invention discloses the use of ultrasound to activate chemicals to significantly improve the disinfectant properties at low concentrations of chemical. Examples of uses of the invention include wastewater treatment, storm water treatment, water reuse, and swimming pool water treatment. In addition to disinfection, the invention may be useful for oxidation reactions, de-colorization and odor removal.

Ships use ballast water to provide stability and maneuverability during a voyage. Water is taken on at one port when cargo is unloaded and usually discharged at another port when the ship receives cargo. Because organisms ranging in size from viruses to fish living in the surrounding water or sediments are taken on board with ballast water, there is a potential for the introduction of non-native organisms into the port of discharge. A number of methods to prevent these unwanted introductions include ballast water exchange, filtration, heat treatment, ozone, ultraviolet and chemical disinfection. However, no single method has been shown to be satisfactory for this use.

Ultrasound energy has been well-documented in killing bacteria and microbes from studies dating back to Wood & Loomis' pioneering work in the 1920s; medical devices currently use this ability in a variety of settings from cleaning instruments to directly applying the energy to patient wounds.

### SUMMARY OF THE INVENTION

This disclosure is directed toward the use of a ballast water treatment (BWT) system of treating ballast water ultrasonically with chemicals, particularly chlorine. Other chemicals such as bromine and hypochlorite salts such as sodium hypochlorite or calcium hypochlorite can be used interchangeably with chlorine. The BWT system and methods are describe as example embodiments of the invention. Other chemicals and embodiments of the technology may be implemented by a person of ordinary skill in the art using this disclosure.

The overall intention of this device is to temporarily enhance chlorine's effectiveness in killing bacteria and organisms through the use of ultrasonics. Ultrasound application allows for significantly lower levels of chlorine to be applied overall then would typically be required to accomplish disinfection to meet water quality criteria for discharging the ballast water directly to a water body.

The BWT system would integrate with new or existing shipboard ballast systems in several ways. For example; 1) it could attach to the ballast water inlet conduits for mixing, sonicating and delivering the activated chemical as it feeds into the ballast tanks, 2) it could attach to the ballast water outlet conduits thereby mixing, sonicating and delivering the activated chemical as ballast water is removed from the ballast tanks, 3) it could be used to treat ballast water within a tank that is recirculated within the ballast tanks, or 4) it could be used to treat ballast water that is transferred between tanks.

The device applies small amounts of chlorine to a portion of the incoming ballast water. This ballast water, mixed with chlorine, is then exposed to sonication. The sonication serves a number of purposes. Examples include: (1) all living organisms and bacteria exposed to the sonication are rapidly deactivated and/or killed, (2) sonication thoroughly mixes and distributes the chlorine throughout the ballast water, (3) the chlorine is activated such that its toxicity and disinfection effectiveness is temporarily increased and (4) the activated chlorine dissipates at an accelerated rate compared to an effective dose without sonication.

The resulting sonicated ballast and chlorine mix is re-introduced with the remaining untreated ballast water whereby the amplified toxicity of the chlorine effectively kills the remaining organisms and bacteria in the ballast tank. This entire process may take place prior to the ballast water entering the ballast tanks.

Due to the use of chlorine, a regulatory permit may be required. It is therefore important the system will work effectively regardless of voyage duration, ship condition or salinity, and does not produce any byproducts that requires additional treatment to render harmless. The released water should be environmentally sound as the “active” phase of the chlorine is will not last for an extended period and is easily accommodated within the vessel. The sonication itself tends to speed up the natural decay of chlorine residual and minimize the total amount of chlorine required to be used.

The BWT system's use of sonicated chlorine is believed to have the ability to kill all living organisms across all target ranges, from zooplankton down to microbes and viruses. The technology may be optimizable to meet all relevant standards without supplemental treatment such as dechlorination.

Application of chlorine is intended to be completely automated to ensure proper mix ratios are maintained over a wide range of ballast flow rates by incorporating electronic controls into the system.

Flow rates of the ballast water and chlorine are monitored and rate of chlorine applied is controlled via the chlorine pump. In the event proper operation cannot be maintained, audible and visual alarms are triggered at both the local and remote interfaces informing the operator of the failure. Examples of the alarms are: mix ratio not maintained chlorine reservoir levels low, ultrasonic hardware failure, etc.

### BRIEF DESCRIPTION OF DRAWINGS

FIG. 1 is a schematic flow diagram of an embodiment of the invention.

FIG. 2 is a representation of an embodiment of the invention showing sidestream treatment of a portion of the ballast water.

FIG. 3 is a cross sectional representation of a ship showing the relative location of the BWT system within the ship.

FIG. 4 is a representation of an embodiment of the invention having an ultrasound horn for chemical mixing.

FIG. 5 is a schematic view of an alternative embodiment of the invention utilizing air pressure to transfer chemicals and ballast water.

FIG. 6 is a schematic view of an alternative embodiment of the invention having a two pass ultrasound tank with opposing ultrasound transducers on each pass.

FIG. 7 is a schematic view of an embodiment of the process control system.

FIG. 8 is a cross sectional view of an alternative embodiment of the invention for small-scale pleasure craft and commercial use.

FIG. 9 is a schematic view of an alternative embodiment of the invention.

FIG. 10 is a schematic view of an alternative embodiment of the invention identifying typical treatment stages.

### DETAILED DESCRIPTION OF THE INVENTION

This ballast water treatment (BWT) system provides for the use of ultrasound to treat ballast water with chemicals, particularly chlorine. Other disinfecting chemicals such as bromine and hypochlorite salts such as sodium hypochlorite or calcium hypochlorite can be used interchangeably with chlorine. The BWT allows disinfection at chemical dosages lower than would otherwise be effective for ballast water treatment. This occurs because of the unique effect ultrasound has on disinfecting chemicals such as chlorine.

Furthermore, the use of ultrasound enhances the removal of residuals so that discharge of the treated ballast water to the environment is allowable without further chemical removal such as a dechlorination step. The BWT system is completely scalable for small units for small pleasure craft to extremely large units for large ships.

Chlorine alone has been shown to be effective at killing living organisms, but the quantities required to treat ballast water would cause the treated ballast water to be too toxic for the environment. Ultrasound alone also has been shown to effectively kill organisms, but the large volume and flow rates typical in shipboard ballast systems likely make ultrasonic treatment alone not cost effective.

While these treatment methods alone are not feasible, the unique interaction ultrasound has on chlorine (and other similar chemicals) would allow the combination of the two to be both safe and effective.

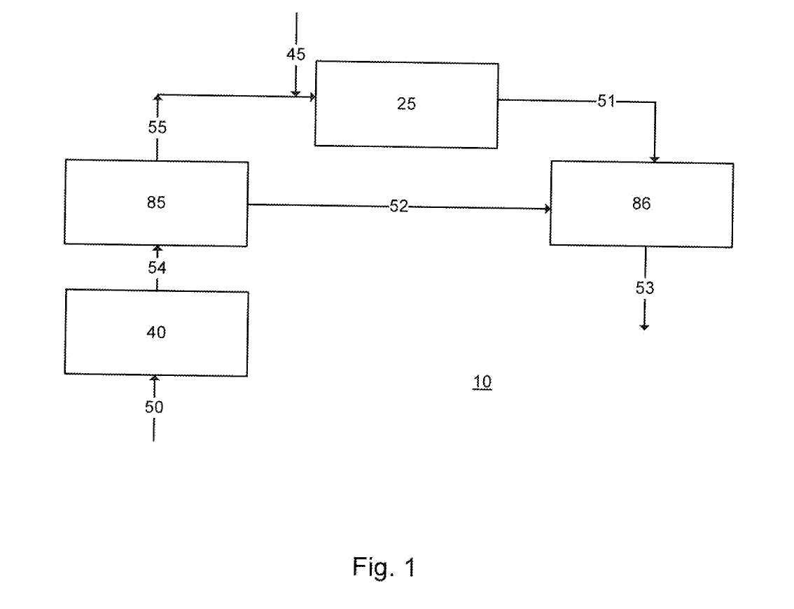

The overall process operates by separating out a small portion of the incoming ballast water as a sonication feed water, adding small amounts of chlorine, ultrasonically charging and dispersing the chlorine throughout the ballast water, then reintroducing the sonicated mixture back into the remaining untreated ballast water prior to entering the ballast tank. This is shown schematically in FIG. 1. Ballast water flow rates typically range from 100 gallons per minute in small vessels to 10,000 gallons per minute in large ships. This process has the advantage of allowing for treating large quantities of ballast water with small quantities of chlorine. Because so little chlorine is utilized, the resulting treated ballast water is non-toxic and safe for discharge into the environment.

FIG. 1 is a schematic flow diagram of an embodiment of the BWT system 10. Typically, ballast water 50 is pulled from the ocean with a ballast water pump 40. Alternatively hydrostatic pressure can be used to provide ballast water to ballast water tanks below the water surface. A separation zone 85 such as a flow splitter is used to divide the untreated fluid 54 or incoming ballast water 50 into a sonication feed water 55, which is the portion producing an activated fluid 51 and a bypass fluid 52, which is the portion that bypasses the activation. The portion of the sonication feed water 55 may be from approximately 1 to 100 percent of the incoming ballast water 50. The portion of the bypass fluid 52 may be from approximately 0 to 99 percent of the incoming ballast water 50. In one embodiment, the activated fluid 51 is about 10 percent of the ballast water 50. The ballast water separated for treatment receives a dosage of a chemical 45 such as bromine, chlorine or a hypochlorite salt. After thorough mixing, the sonication feed water 55 is then subject to ultrasound activation in an ultrasound tank 25 to produce an activated fluid 51. The sonication time within the ultrasound tank 25 may vary between 0.1 sec and 24 hours. A sonication time in the range of 10 to 20 seconds is preferred. The bypass fluid 52 and the activated fluid 51 are then mixed thoroughly in a recombining zone 86 to allow the activated chemicals to disinfect the organisms in the total flow of ballast water 50.

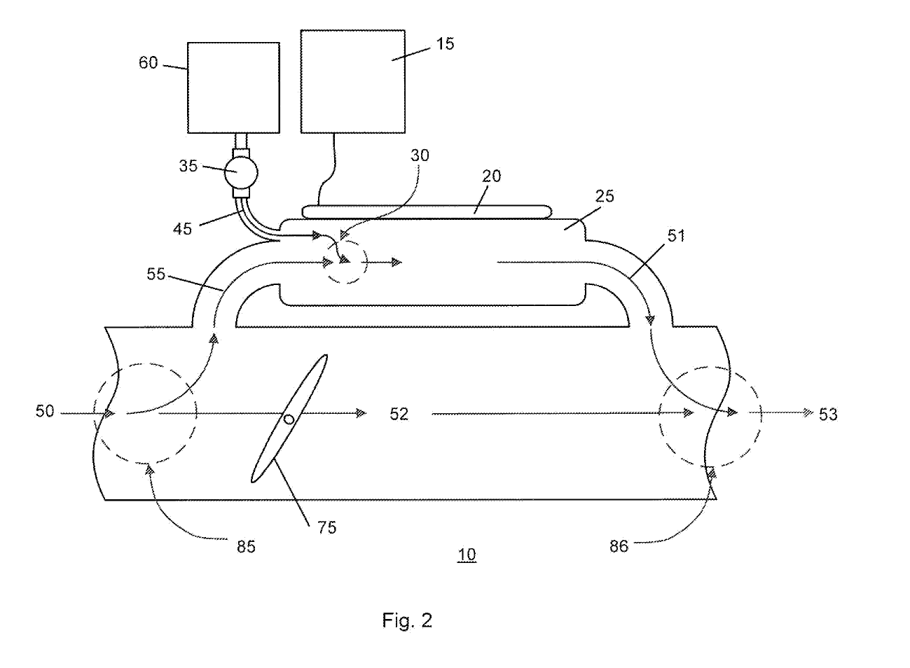

FIG. 2 is a representation of an embodiment of the BWT system 10 showing sidestream treatment of a portion of the ballast water as would be typically implemented in large ships. As shown in FIG. 2 the separation zone 85 can be accomplished by a simple flow splitter such as a valve 75, baffle or restriction such as an orifice plate. A chemical feed pump 35 moves chemical 45 from a chemical reservoir 60 to a point for chemical mixing 30. The chemical reservoir 60 size and shape can be tailored for each ship's needs. The chemical mixing 30 is utilized to assure uniform dispersion of the chemical added for activation. Mixing can occur with the sonication feed water 55 for example, generating turbulence within an initial portion of the ultrasound tank 25, a separate mixing chamber or a mixing device such as a static mixer or mechanical mixer may be provided.

An ultrasonic generator 15 is used to drive an ultrasound transducer 20. The ultrasound generator 15 may produce a wave pattern having a shape of square, sinusoidal, trapezoidal, triangular. The ultrasound transducers 20 are bonded to the walls of the ultrasound tank 25 to transmit ultrasonic energy into the ballast water 50 as it flows through the ultrasound tank 25. The ultrasound transducer 20 may be located on a single side wall or a plurality of side walls of the ultrasound tank 25. The ultrasonic tank 25 may be constructed of stainless steel and utilizes magnetostrictive ultrasound transducers 20. All remaining materials and components are of standard materials typically found in ships (standard plumbing, electrical and sensors).

Any given ultrasound transducer 20 within the ultrasonic tank 25 may emit ultrasonic waves of a particular frequency and/or amplitude or may emit ultrasonic waves into the ultrasonic tank 25 varying in frequency and/or amplitude. The frequency of the ultrasonic waves emitted by a ultrasound transducer 20 should be at least approximately 18 kHz. Preferably a transducer emits ultrasonic waves into the ultrasonic tank 25 with a frequency between approximately 20 kHz and approximately 200 kHz or between approximately 1 MHz and approximately 5 MHz. The amplitude of the ultrasonic waves emitted into the fluid by a ultrasound transducer 20 should be at least approximately 1 micron or greater.

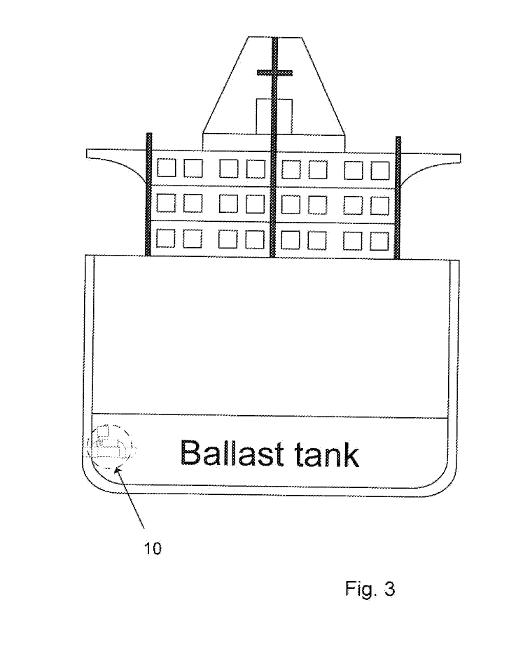

FIG. 3 presents a cross sectional representation of a ship showing the relative location of the BWT system 10 within the ship. Retrofitting an installation on an existing ship would typically involve hydraulically coupling the BWT system into the existing ballast water piping. Installations on new vessels typically allow greater flexibility. With appropriate piping configurations, the BWT system 10 may be provided to treat incoming ballast water, treat discharging ballast water, or to treat ballast water being transferred inter-tank or intra-tank within a ship.

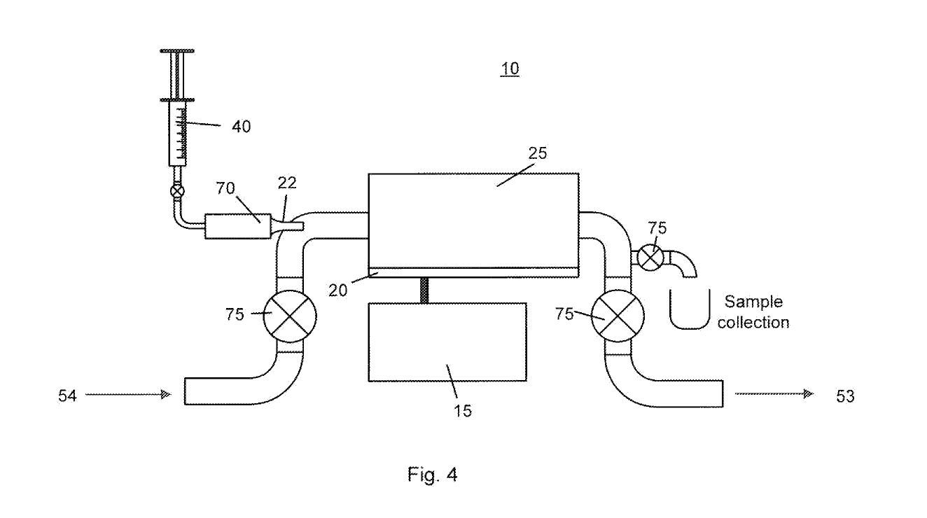

FIG. 4 is a representation of an embodiment of the invention having an ultrasound transducer coupled to an ultrasound horn 22 to serve as a mixer 70. Mixing using the ultrasound waves utilizes the inlet conduit of the ultrasound chamber 25 to mix the chemical 45 with the untreated fluid 54 to be activated prior to the ultrasound chamber 25. In this embodiment additional activation of the chemical 45 may be achieved as the chemical travels through the ultrasound horn as well as from the sonication that occurs near the radiation surface of the ultrasound horn 22. This additional chemical activation occurs prior to the activation that occurs within the ultrasound tank 25 itself.

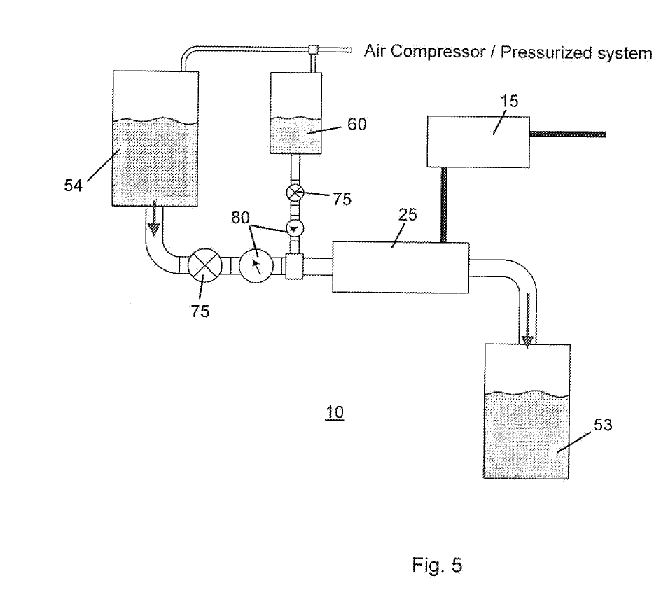

FIG. 5 is a schematic view of a BWT system 10 utilizing air pressure to transfer fluids. In this embodiment, ballast water 50 may be supplied to holding tanks using feed pumps or hydraulic head or elevational differences between the water source and the holding tanks. The holding tank, may then be pressurized to provide the driving force to move the ballast water 50 through the system. Valves 75 and flow meters 80 may be provided to control the flow rates without the use of pumps.

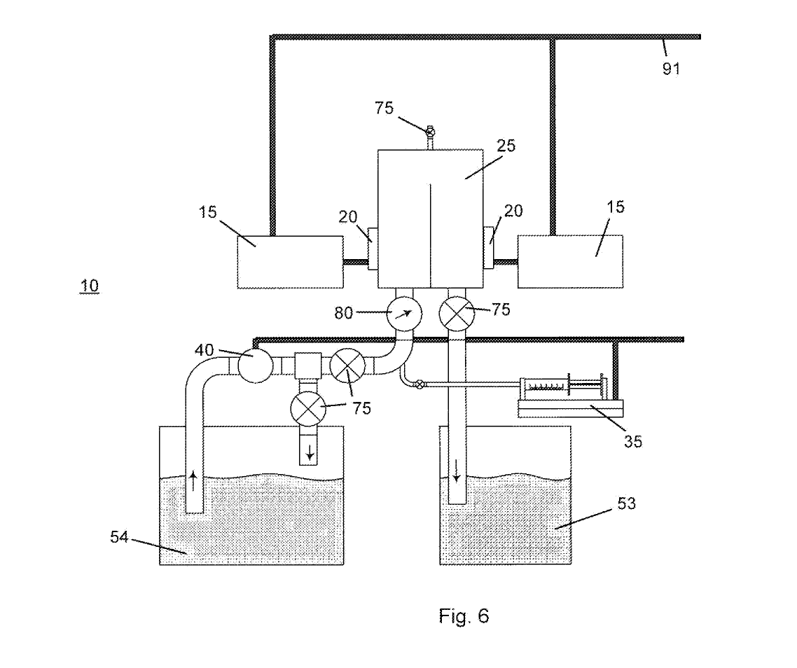

FIG. 6 is a schematic view of an alternative embodiment of the invention having a two pass ultrasound tank 25 with opposing ultrasound transducers 20 on each pass. The ultrasound tank 25 may be provided with a valve 75 for air release used particularily during filling or draining operations. If the tank holding the treated fluid 53 and untreated fluid 54 are separate units, inter-tank treatment would be provided. Alternatively a single tank could be used to provide intra-tank treatment of ballast water 50. This embodiment might be useful to maintain the treatment and prevent organism regrowth during extended periods or increase the treatment provided to the ballast water 50.

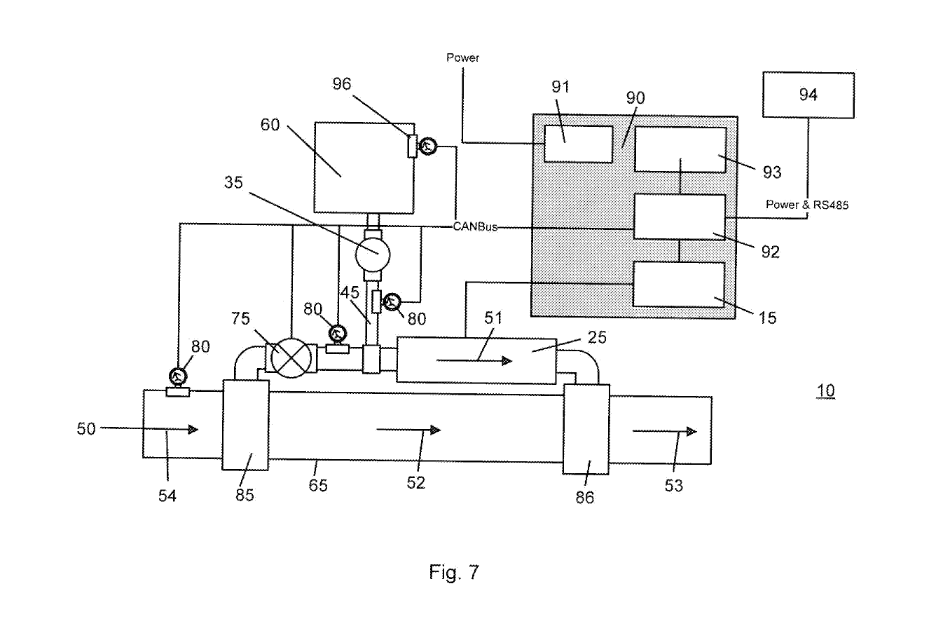

FIG. 7 is a schematic view of an embodiment with an electronic control system 90 (ECS 90). The ECS 90 is typically located near the ultrasound tank 25. Having a power supply 91 and a CPU 92, the ECS 90 monitors the total ballast water flow rate, calculates and controls the flow rate of sonicated ballast water and chlorine applied and controls operation of the ultrasonic generator 15. The ECS 90 further provides an array of operational information to the operator via both the local interface 93 and remote interface 94 as well as allows for manual over-rides and shutdown. The ECS 90 typically collects signals from and may control valves 75, flow meters 80, and liquid level sensors 96.

The liquid level sensor 96 utilized by the ECS 90 to monitor levels of chlorine in a chemical reservoir 60 as well as provide sufficient warnings when more should be added. The flow rate meters 80 or sensors are utilized by the ECS 90 to monitor flow rates of total ballast water, chlorine applied and sonicated ballast water. Electronically controlled valves 75 are utilized by the ECS 90 to control the flow rate of sonicated ballast water. Manual override capability can be provided for repair purposes. The remote interface 94 is intended for installation in the ship's bridge, the remote interface provides real time operational information to the operator such as ballast water flow rates, rate of chlorine applied, chlorine reservoir levels and any error alarms.

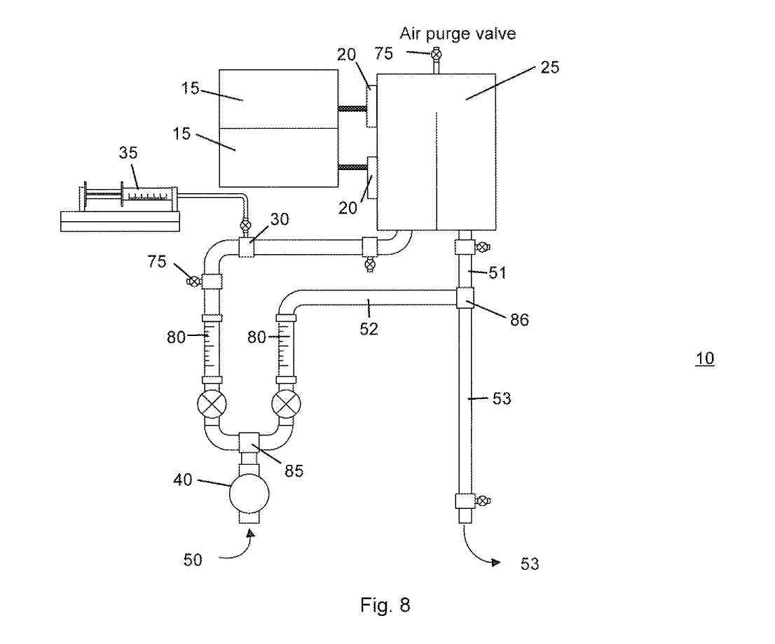

FIG. 8 is a schematic view of an embodiment of the smaller scale BWT 10 such as might be used on a pleasure craft. This embodiment shown having transducers 20 along one side of a 2-pass ultrasound tank 25. The second pass would provide additional contact time as well as supplemental sonication from the ultrasound energy not adsorbed in the first pass that may travel through the baffle separating the passes.

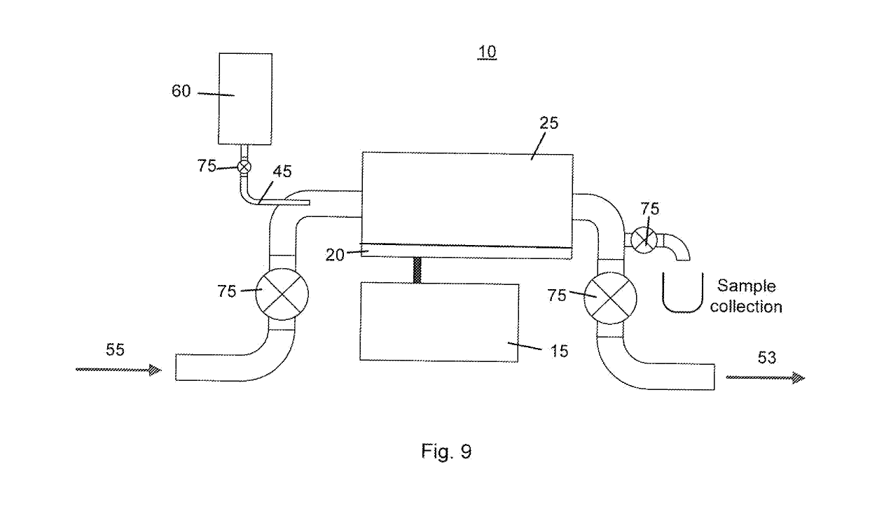

FIG. 9 is a schematic view of an embodiment of the BWT 10 having all ballast water 50 passing through the ultrasound tank 25. In this embodiment 100 percent of the ballast water 50 is activated fluid 53. These flows may not be exactly the same due to minor losses such as evaporation or sampling and/or additions such as chemicals 60. This embodiment is useful for small-scale systems or systems designed for intra-tank or inter-tank transfer where a bypass fluid would not be useful.

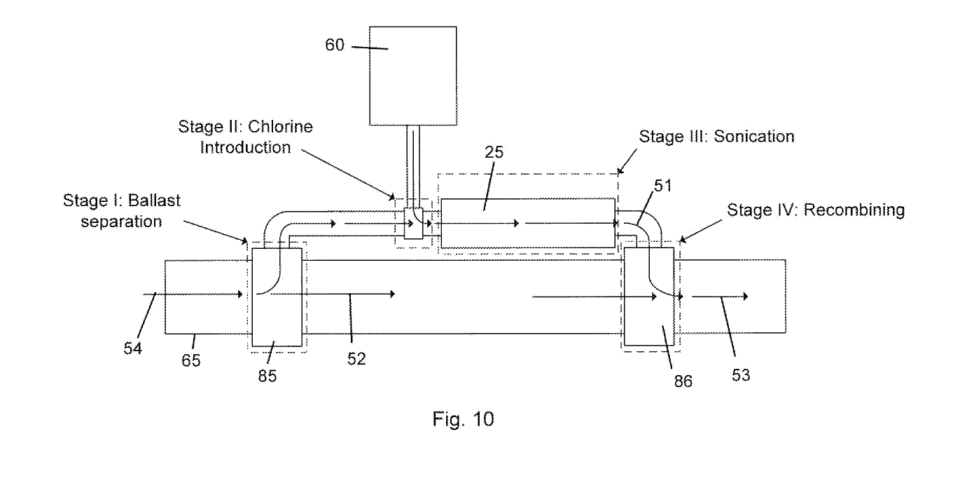

FIG. 10 is a schematic representation of the treatment stages of the BWT 10.
Stage I: Ballast water separation—A portion of the incoming ballast water is diverted to the ultrasonic tank 25 at a separation zone 85.
Stage II: Chlorine introduction—Small amounts of chlorine are introduced into the diverted ballast water or sonication feed water 55.
Stage III: Sonication—Ultrasonic transducers installed on the chamber break up and disperse the chlorine and evenly disperse it within the diverted ballast water. At this stage, all living organisms within the diverted ballast water are killed as a result of exposure to ultrasonic cavitation.
Stage IV: Recombining—Following sonication, the diverted ballast water and chlorine mix are re-introduced/remixed with the undiverted ballast water or bypass fluid 52 at a recombining zone 86. At this stage, the chlorine is still charged/active and degrade or kill all remaining organisms within the untreated fluid 54.

Although specific embodiments of apparatuses and methods using the apparatus as an example, have been illustrated and described herein, it will be appreciated by those of ordinary skill in the art that any arrangement, combination, and/or sequence that is calculated to achieve the same purpose may be substituted for the specific embodiments shown. It is to be understood that the above description is intended to be illustrative and not restrictive.

Combinations of the above embodiments and other embodiments as wells as combinations and sequences of the above methods and other methods of use will be apparent to individuals possessing skill in the art upon review of the present disclosure. The scope of the claimed apparatus and methods should be determined with reference to the appended claims, along with the full scope of equivalents to which such claims are entitled.

I claim:

1. A ballast water treatment device comprising:
a fluid conduit for supplying a ballast water to a flow splitter;
the flow splitter separating a bypass fluid and a sonication feed water from the ballast water;
the sonication feed water receiving a chemical;
the sonication feed water in fluid communication with an ultrasound tank having an ultrasound transducer;
the ultrasound transducer emitting ultrasonic waves at a frequency and an amplitude to generate an activated fluid in the tank; and
the activated fluid combined with the bypass fluid to produce a treated fluid.

2. The device of claim 1 also having a mixer for mixing the chemical with the sonication feed water.

3. The device of claim 1 also having an ultrasound horn for mixing the chemical with the sonication feed water.

4. The device of claim 1 wherein the chemical is chlorine.

5. The device of claim 1 having the ultrasound waves with the amplitude of 1 micron or greater.

6. The device of claim 1 having the fluid exposed to the ultrasonic waves for at least 5 seconds.

7. The device of claim 1 having the ultrasound waves with the frequency within the range of 20 kHz to 200 kHz.

8. The device of claim 1 having the ultrasound waves with the frequency within the range of 1 mHz to 5 mHz.

9. The device of claim 1 having the ultrasound transducer driven by a wave pattern selected from the group of consisting of; square, sinusoidal, trapezoidal, triangular.

10. A method for treating ballast water comprising the steps of:
delivering the ballast water through a fluid conduit to a separation zone;
dividing the ballast water into a sonication feed water and bypass fluid;
dosing the sonication feed water with a chemical;
sonicating the sonication feed water within an ultrasound tank to generate an activated fluid; and
recombining the activated fluid with the bypass fluid to produce a treated fluid.

11. The method of claim 10 wherein the fluid conduit is on an inlet conduit to a ballast tank.

12. The method of claim 10 wherein the fluid conduit is on an outlet conduit to a ballast tank.

13. The method of claim 10 having the additional step of activating the chemical within an ultrasound horn.

14. The method of claim 10 wherein the sonication feed water is about 10 percent of the ballast water.
